(19) United States
(12) Patent Application Publication
(10) Pub. No.: US 2002/0066463 A1
(43) Pub. Date: Jun. 6, 2002

(54) Methods and apparatus for cleaning reticles

(75) Inventor: Masashi Okada, Inashiki (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/001,537

(22) Filed: Nov. 13, 2001

(30) Foreign Application Priority Data
Dec. 4, 2000 (JP) 2000-368091

(51) Int. Cl. B08B 3/12

(52) U.S. Cl. 134/1; 134/184

(57) ABSTRACT

Methods and apparatus are disclosed for cleaning reticles, especially stencil reticles for use in charged-particle-beam microlithography, for example. One or more reticles are mounted to a reticle holder that holds the periphery of the reticle(s). Thus mounted, the reticles are placed in a cleaning solution in an ultrasonic cleaner tank such that the plane of the reticle membrane is oriented perpendicularly to the propagation direction of ultrasonic waves propagating from the ultrasonic transducer(s).

### FIELD

This disclosure is directed to reticles as used in microlithography, especially as used in charged-particle-beam microlithography. More specifically, the disclosure pertains to cleaning foreign matter (especially particulate matter) from such reticles.

### BACKGROUND

Progress in microelectronic-device-fabrication technology is exemplified by progress in microlithographic exposure technology, by which circuit patterns are imprinted on any of various “substrates” (typically a semiconductor wafer). As the limitations of optical microlithography have been increasingly apparent, considerable attention has been devoted to producing a practical “next generation” microlithography technology. Most of this effort has focused on the use of a charged particle beam (e.g., electron beam or ion beam) or a “soft X-ray” beam. In either of these approaches, the microlithographic pattern to be transferred to the wafer or other substrate is defined on a reticle or mask (generally termed a “reticle” herein). The manufacture of useful reticles for these “next generation” microlithography technologies has posed a number of technical challenges.

The only currently practical reticle for use in charged-particle-beam microlithography is a so-called “segmented” reticle in which the pattern defined by the reticle is divided among a large number of “subfields” each defining a respective portion of the overall pattern. Individual subfields are separated from one another by supporting struts that strengthen and rigidify the reticle. A major type of segmented reticle is a so-called “stencil” reticle in which, in each subfield thereof, pattern elements are defined as respective through-holes in a scattering membrane.

According to a conventional method for manufacturing a stencil reticle, a “reticle blank” is prepared by defining regions on a silicon wafer in which subfields are to be located. The wafer is patterned and etched to define a grid of supporting struts between which the respective membrane regions of individual subfields extend. Then, the pattern to be defined by the reticle is formed on the reticle, wherein each subfield of the reticle blank is patterned with the respective portion of the overall pattern.

A schematic plan view of a representative segmented reticle 40 as described above is shown in FIG. 4(A), and a schematic elevational section of a portion of the reticle (along the line B-B′ in FIG. 4(A)) is shown in FIG. 4(B). The reticle 40 comprises a base material 41 (residual portions of the silicon wafer from which the reticle blank was made) that is divided into an array of multiple subfields 42. The subfields 42 are separated from one another by struts 43. Referring now to FIG. 4(B), the base material 41 is depicted as relatively wide units of material on the left and right ends of the depicted portion. Also shown are two exemplary struts 43 and three exemplary subfields 42. Each subfield 42 includes a respective portion of the reticle membrane 44. Individual pattern features are defined by corresponding through-holes 45 in the membrane 44.

All reticles are vulnerable to particulate contamination. Such contamination should be removed before using the reticle for microlithographic exposures. For example, if a contaminant particle is a charged-particle absorber and is lodged on the scattering membrane 44, then the local excess absorption causes deformation of the pattern as transferred to the lithographic substrate. A problem with stencil reticles is that foreign particulate matter can become lodged in an aperture 45 defining a pattern element. Such an entrapped particle produces a local “shadow” on the lithographic substrate that results in a pattern defect. Pattern defects cause malfunctions and/or other operational defects in microelectronic devices produced by fabrication processes involving microlithography.

A currently widely used method for removing contaminant particles from a reticle involves washing the reticle in an ultrasonic cleaner. The reticle is immersed in a cleaning solution in the ultrasonic cleaner. Generation of ultrasonic waves in the cleaning solution in which the reticle is immersed tends to dislodge the particles. In conventional ultrasonic cleaners the ultrasonic transducer is attached to the underside of the bottom of the washing tank holding the cleaning solution. Normally, multiple reticles are cleaned at a time. The reticle(s) are held in a vertical orientation in a rack that is lowered (while the reticles remain vertical) into the cleaning solution.

Thus, the surfaces of the reticle membranes inevitably are oriented parallel to the propagation direction of ultrasonic waves that impinge on the reticles. This is shown in FIG. 5, which depicts (in elevational view) a region of a reticle immersed in the cleaning tank of a conventional ultrasonic cleaner. The depicted region includes portions of the reticle membrane 44 and several through-holes 45. The plane of the reticle membrane 44 is parallel to the plane of the page. Particulate matter 52 can be seen adhering to the surface of the membrane. Other particulate matter 53 can be seen adhering to the side walls of certain through-holes 45. Arrows 51 indicate the direction of propagation of ultrasonic waves impinging on the reticle. I.e., the ultrasonic waves propagate in a direction parallel to the membrane 44. The ultrasonic waves interact with particles 52 on the surface of the membrane 44 sufficiently for dislodging the particles. However, the ultrasonic waves do not interact sufficiently with particulate matter 53 adhering to the side walls of the through-holes 45, due to the ultrasonic waves being cut off by the side walls. As a result, the particles 53 tend not to be dislodged. Simply increasing the power of the ultrasonic energy to increase the washing effect does not solve this problem because ultrasonic waves having increased energy tend to fracture the thin membranes 44.

### SUMMARY

In view of the shortcomings of conventional methods and apparatus as summarized above, the present invention provides, inter alia, reticle-washing methods and apparatus that produce a more thorough ultrasonic cleaning effect than conventional methods and apparatus, especially with respect to dislodging contaminant particles adhering to the side walls of pattern-element-defining apertures in stencil reticles.

To such end, and according to a first aspect of the invention, methods are provided for cleaning a reticle. In an embodiment of such a method the reticle is placed in a liquid cleaning solution. Ultrasonic waves are transmitted from an ultrasonic transducer into the cleaning solution such that the ultrasonic waves from the transducer impinge on the reticle perpendicularly to a major surface of a membrane of the reticle and cause foreign matter adhering to the reticle to detach from the reticle into the cleaning solution.

The ultrasonic waves propagating through the cleaning solution from the transducer impinge directly on foreign matter adhering not only to the major surface of the membrane but also to side walls of the minute through-holes (apertures) that define individual respective pattern features without the impinging waves being cut off by other reticle structure. Thus, the foreign matter adhering to the major surfaces of the membrane and to the side walls of the minute apertures is more easily and more completely removed.

Desirably, the cleaning solution includes a surface-active agent (“surfactant”). Further desirably, the cleaning solution is alkaline, with a pH of 8 or higher. The alkalinity is especially effective in removing metal and ceramic foreign particles from silicon stencil reticles.

The reticle to be cleaned typically has a non-patterned peripheral portion surrounding the patterned portion (containing the subfields). The method can further include the step of mounting the reticle in a reticle holder before placing the reticle in the cleaning solution. The reticle holder desirably is configured as having a peripheral portion defining a central void, wherein the peripheral portion is configured to hold the periphery of the reticle, and the void is configured as being at least as large as the patterned portion of the reticle.

According to another aspect of the invention, apparatus are provided for cleaning reticles. An embodiment of such an apparatus comprises a tank configured to contain a liquid cleaning solution and configured to accommodate at least one reticle immersed in the cleaning solution in the tank for cleaning. The apparatus also includes first and second ultrasonic transducers contacting respective opposing side walls of the tank. The transducers are mounted such that energization of the transducers causes waves of ultrasonic energy to propagate in respective propagation directions in the cleaning solution away from the respective transducers. The apparatus also can include a power supply connected to the transducers, wherein the power supply is configured to energize the transducers in a manner causing the transducers to generate the respective ultrasonic energy.

With such an apparatus, reticles can be immersed vertically into the cleaning solution (i.e., immersed in a direction perpendicular to the surface of the cleaning solution in the tank) while having the reticles be oriented, after such immersion, to have the ultrasonic waves impinge perpendicularly on major surfaces of the reticles. Such a configuration provides effective and more complete removal of foreign material from the reticles, including foreign material lodged in the minute through-holes in stencil reticles, without damaging the reticles. For example, whenever the reticles are being immersed in, removed from, or moved within the cleaning solution, the hydraulic resistance imparted to the reticles by the cleaning solution is reduced, thereby reducing reticle fracture during cleaning. In addition, this apparatus allows multiple reticles to be cleaned simultaneously, without compromising cleaning efficacy.

The foregoing and additional features and advantages of the invention will be more readily apparent from the following detailed description, which proceeds with reference to the accompanying drawings.

### BRIEF DESCRIPTION OF THE DRAWINGS

FIG. 1 schematically depicts a reticle-cleaning apparatus and method according to a first representative embodiment.

FIG. 2 schematically depicts a reticle-cleaning apparatus and method according to a second representative embodiment.

FIG. 3(A) is a plan view of an exemplary reticle holder suitable for holding the reticle while the reticle is being cleaned.

FIG. 3(B) is an elevational section along the line A-A′ in FIG. 3(B).

FIG. 4(A) is a schematic plan view of a conventional segmented stencil reticle.

FIG. 4(B) is a schematic elevational section of a portion of the reticle of FIG. 4(A), along the line B-B′ in FIG. 4(A).

FIG. 5 is an elevational view of a portion of a stencil reticle oriented relative to the conventional propagation direction of ultrasonic waves used for cleaning the reticle, wherein the propagation direction is parallel to the plane of the reticle membrane.

### DETAILED DESCRIPTION

The invention is described below in the context of multiple representative embodiments, which are not intended to be limiting in any way.

First Representative Embodiment

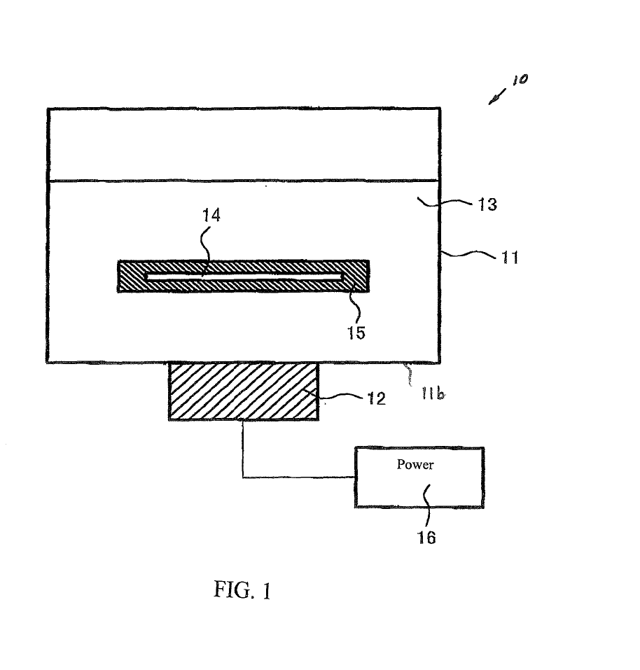

This embodiment is depicted schematically in FIG. 1. The depicted apparatus 10 includes a tank 11, an ultrasonic transducer 12, and a power supply 16 that energizes the transducer 12. The tank 11 contains a cleaning solution 13 in which a reticle 14 is immersed. For immersion, the reticle is held in a reticle holder 15.

In this embodiment, the ultrasonic transducer 12 is attached to the underside of the bottom surface 11b of the tank 11. Thus, whenever the transducer 12 is energized by the power supply 16, the ultrasonic energy generated by the transducer 12 causes the bottom surface 11b of the tank 11 to vibrate, and ultrasonic waves to propagate upward into the cleaning solution 13.

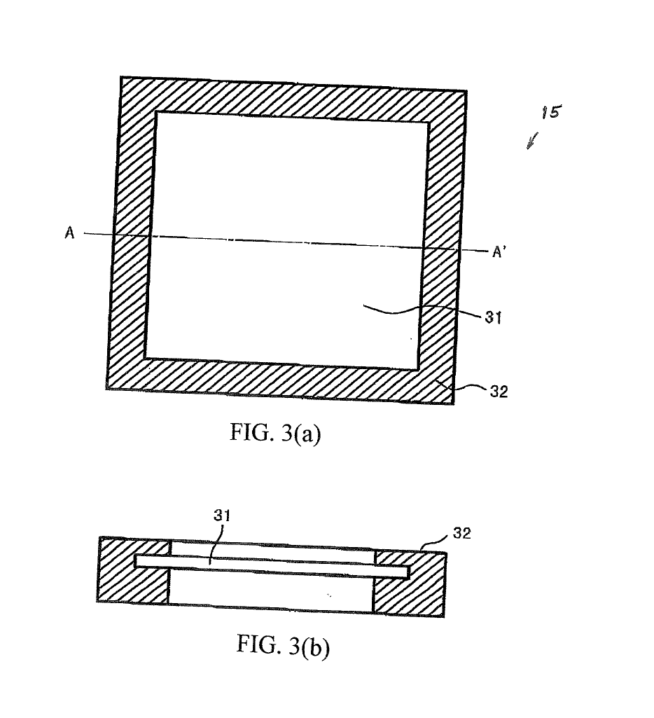

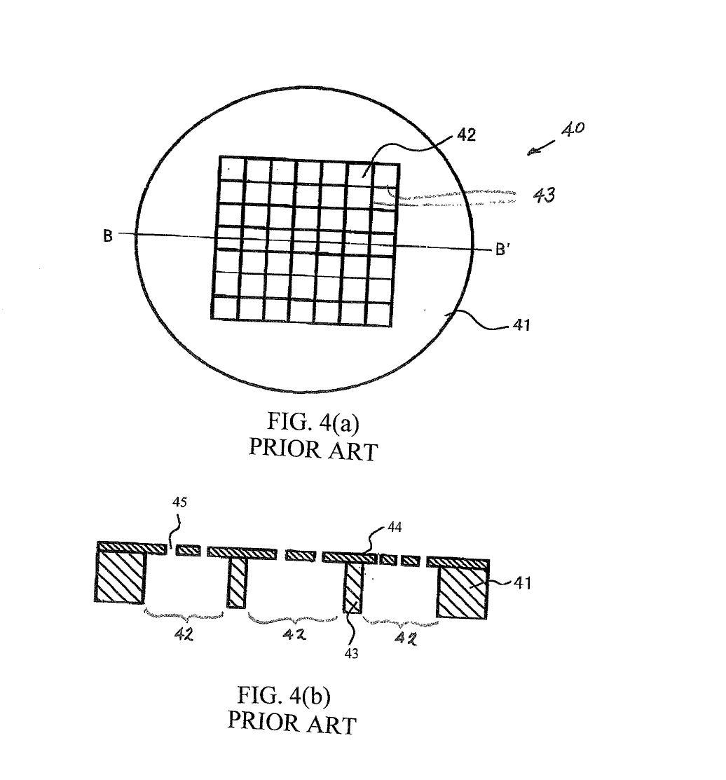

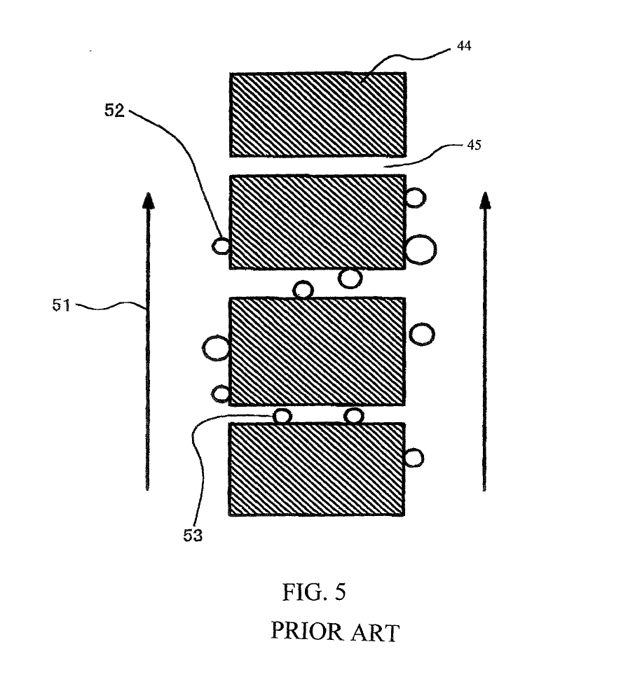

The reticle 14 (mounted in the holder 15) is immersed in the cleaning solution 13 such that the membrane surface of the reticle 14 is parallel to the bottom surface 11b of the tank 11. With such an orientation, the ultrasonic waves propagating upward in the cleaning solution 13 from the bottom surface 11b impinge at a normal angle of incidence on the surface of the reticle membrane. (I.e., the ultrasonic waves impinge perpendicularly on the membrane surface.) An exemplary reticle holder 15 is depicted schematically in FIGS. 3(A) and 3(B), wherein FIG. 3(A) is a plan view and FIG. 3(B) is an elevational section along the line A-A′ of FIG. 3(A). The reticle holder 15 is essentially a frame 32 that defines a central void 31. Whenever the reticle 14 is held in the holder 15 the frame 32 contacts the periphery of the reticle, and the pattern-defining portions of the reticle are situated within the void 31. As a result, whenever the reticle 14 and holder 15 are immersed in the tank 11 in a manner as shown in FIG. 1, for example, the ultrasonic waves impinge (at normal incidence) directly and without obstruction on the pattern-defining membrane areas of the reticle. By placing the reticle surface relative to the propagation direction of the ultrasonic waves in this manner, the side walls of the pattern-element-defining through-holes are oriented parallel to the propagation direction of the ultrasonic waves, allowing the ultrasonic waves to directly impinge on any particles adhering to the side walls. In other words, the ultrasonic waves are not cut off by the side walls, thereby allowing more ultrasonic energy actually to impinge on the particles. Consequently, the particles are more easily and more likely dislodged during cleaning.

Desirably, the cleaning solution 13 is an alkaline (pH≧8) aqueous solution of a surface-active agent (surfactant). The surfactant solute can be any of various surfactants that does not damage the reticle but that effectively removes (as an alkaline solution) metal and ceramic particles from silicon stencil reticles.

Second Representative Embodiment

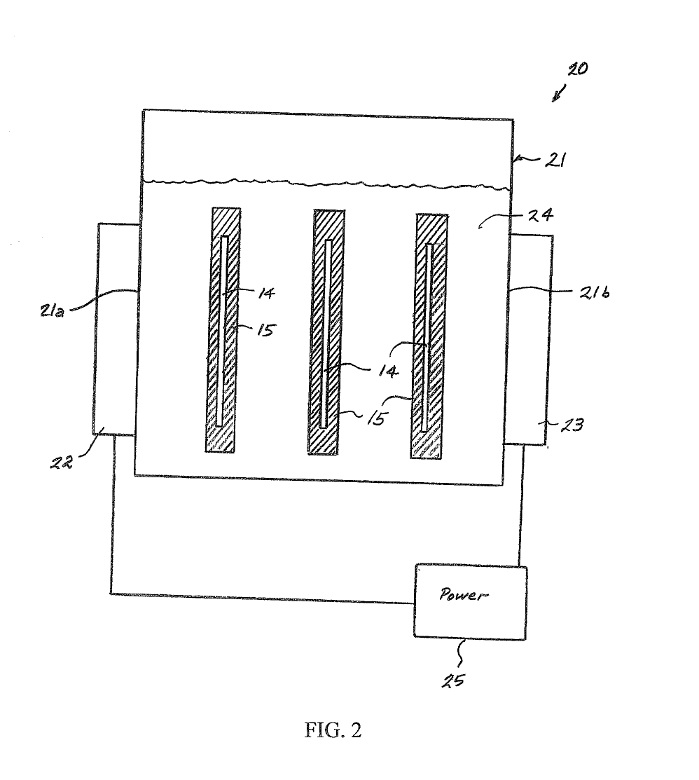

This embodiment is depicted schematically in FIG. 2. The depicted apparatus 20 includes a washing tank 21, ultrasonic transducers 22, 23, and a power supply 25 that energizes the transducers 22, 23. The tank 21 contains a cleaning solution 24 in which a reticle 14 is immersed. For immersion, the reticle is held in a reticle holder 15.

The transducers 22, 23 are attached to respective outsides of opposing side walls 21a, 21b of the tank 21. Thus, whenever the transducers 22, 23 are energized by the power supply 25, the ultrasonic energy generated by the transducers 22, 23 causes the sides 21a, 21b of the tank 21 to vibrate, and ultrasonic waves to be introduced laterally into the cleaning solution 24.

The reticle 14 (mounted in the holder 15) is immersed in the cleaning solution 24 such that the membrane surface of the reticle 14 is parallel to the sides 21a, 21b of the washing tank 21. With such an orientation, the ultrasonic waves propagating laterally in the cleaning solution 24 from the sides 21a, 21b impinge at a normal angle of incidence on the surface of the reticle membrane. (I.e., the ultrasonic waves impinge perpendicularly on the membrane surface.)

By placing the reticle surface relative to the propagating directions of the ultrasonic waves in this manner, the side walls of the pattern-element-defining through-holes are oriented parallel to the propagation directions of the ultrasonic waves, allowing the ultrasonic waves to impinge directly on any particles adhering to the side walls of the through-holes. In other words, the ultrasonic waves are not cut off by the side walls, which provides more ultrasonic energy actually impinging on the particles. Consequently, the particles are more easily and more likely dislodged during cleaning.

Another advantage of this embodiment is that the reticle 14 can be inserted into and removed from the cleaning solution 24 or moved from one location to another in the cleaning solution 24 with minimal hydraulic force being applied to the membrane. Hence, the probability of membrane fracture with this embodiment is lower than with the first representative embodiment. Also, this embodiment more readily allows multiple reticles to be cleaned simultaneously.

Desirably, as in the first representative embodiment, the cleaning solution 24 is alkaline (pH≧8) and contains a surface-active agent (surfactant). Such a solution 24 is effective for removing metal and ceramic particles from silicon stencil reticles.

The following examples are provided to more fully describe various aspects of the invention, but are not intended to be limiting in any way.

### EXAMPLE 1

This example is of the first representative embodiment, and reference is made to FIG. 1. The surfactant-containing cleaning solution 13 in this example had a pH of 12. The tank 11 had a single transducer 12 attached to the underside of the bottom wall 11b of the tank. Thus, actuation of the transducer 12 caused ultrasonic waves to propagate upward into the cleaning solution 13. The vibration frequency of the transducer 12 was 1 MHz, at an input power of 300 W. The reticle 14 was a stencil reticle in which the minimum feature size was 0.3 μm in width (i.e., the minimum width of the through-holes in the pattern defined on the reticle was 0.3 μm). The reticle membrane was silicon, 2 μm thick. The reticle 14 was mounted in a reticle holder 15 and immersed in the tank with the reticle surface oriented perpendicularly to the propagation direction of the ultrasonic waves. I.e., the reticle surface was oriented parallel to the bottom wall 11b of the tank 11. These conditions achieved removal of particulate foreign matter from not only the surface of the membrane but also from the side walls of the through-holes in the membrane.

Although, in this embodiment, the transducer 12 was actuated at 300 W, this power figure is not intended to be limiting. The transducer 12 can be driven at any of various power levels so long as the reticle 14 does not fracture.

### EXAMPLE 2

This example is of the second representative embodiment, and reference is made to FIG. 2. The surfactant-containing cleaning solution 24 in this example had a pH of 12. The subject reticle 14 was a stencil reticle having a silicon membrane 2 μm thick, with a minimum feature size of 0.3 μm. The reticle 14 was mounted in a reticle holder 15. Three such mounted reticles 14 were immersed in the tank 21 with the reticle surfaces oriented parallel to each other and perpendicularly to the propagation direction of the ultrasonic waves. I.e., the reticle surfaces were oriented parallel to the side walls 21a, 21b of the tank 21. These conditions achieved removal of particulate foreign matter from not only the surfaces of the membranes but also from the side walls of the through-holes in the membranes.

The transducers 22, 23 were driven at a frequency of 1 MHz at an input power of 200 W. As noted above, these figures are not intended to be limiting. The transducers 22, 23 can be driven at any of various power levels so long as the reticle(s) 14 do not fracture.

Whereas the invention has been described in connection with multiple representative embodiments and examples, it will be understood that the invention is not limited to those examples. On the contrary, the invention is intended to encompass all modifications, alternatives, and equivalents as may be included within the spirit and scope of the invention, as defined by the appended claims.

What is claimed is:

1. A method for cleaning a reticle, comprising:
placing the reticle in a liquid cleaning solution; and
transmitting ultrasonic waves from an ultrasonic transducer into the cleaning solution such that the ultrasonic waves from the transducer impinge on the reticle perpendicularly to a major surface of a membrane of the reticle and cause foreign matter adhering to the reticle to detach from the reticle into the cleaning solution.

2. The method of claim 1, wherein the reticle has a non-patterned peripheral portion surrounding a patterned portion, the method further comprising the step of mounting the reticle in a reticle holder before placing the reticle in the cleaning solution, the reticle holder being configured as having a peripheral portion defining a central void, wherein the peripheral portion is configured to hold the periphery of the reticle, and the void is configured as being at least as large as the patterned portion of the reticle.

3. The method of claim 1, wherein the reticle is placed in a cleaning solution including a surface-active agent.

4. The method of claim 3, wherein the cleaning solution is alkaline, with a pH of 8 or higher.

5. The method of claim 1, wherein the reticle is placed in a cleaning solution that is alkaline, with a pH of 8 or higher.

6. An apparatus for cleaning a reticle, comprising:
a tank configured to contain a liquid cleaning solution and configured to accommodate at least one reticle immersed in the cleaning solution in the tank for cleaning; and
at least one ultrasonic transducer contacting a side wall of the tank, the transducer being mounted such that energization of the transducer causes waves of ultrasonic energy to propagate into the cleaning solution.

7. The apparatus of claim 6, comprising first and a second ultrasonic transducer contacting respective opposing side walls of the tank, the transducers being mounted such that energization of the transducers causes waves of ultrasonic energy to propagate in respective propagation directions in the cleaning solution away from the respective transducers.

8. The apparatus of claim 7, further comprising a power supply connected to the transducers, the power supply being configured to energize the transducers in a manner causing the transducers to generate the respective ultrasonic energy.

9. The apparatus of claim 6, further comprising a power supply connected to the at least one ultrasonic transducer, the power supply being configured to energize the at least one transducer in a manner causing the at least one transducer to generate the respective ultrasonic energy.
